(19) United States
(12) Patent Application Publication
(10) Pub. No.: US 2008/0028331 A1
(43) Pub. Date: Jan. 31, 2008

(54) Graphical interface for configuring enterprise-wide computer systems

(75) Inventors: Michael B. O'Flaherty, Streetsboro, OH (US); Jay Cross, Polson, MT (US); Barry J. Markwitz, Solon, OH (US)

Correspondence Address: James A. Hudak, Esq., Suite #304, 29425 Chagrin Boulevard, Cleveland, OH, 44122, US

(73) Assignee: TimeKeeping Systems, Inc.

(21) Appl. No.: 11/493,135

(22) Filed: Jul. 27, 2006

(51) Int. Cl. G06F 3/048

(52) U.S. Cl. 715/771

(57) ABSTRACT

A system utilizing a graphical interface for configuring an enterprise-wide computer system is disclosed. The system operator “drags” graphic icons from a repository by using a mouse or other pointing device and places the icons in a workspace area to produce a graphical representation of the network utilized by the computer system. The icons represent network components, software components and interconnections of the system to be configured. The properties of the components are then defined and links representing connections or the flow of data are created by drawing lines between components or by “dragging” icons representing such connections into the workspace area. When the graphical representation of the network utilized by the computer system has been completed, a program is initiated using the graphical representation to properly configure the software required for same. The resulting configuration diagrams and element properties can be saved in a storage device for later-application, and/or can be printed for reference purposes.

### TECHNICAL FIELD

The present invention relates, in general, to an enterprise-wide computer system and, more particularly, to a graphical interface for configuring an enterprise-wide computer system.

### BACKGROUND ART

Present computer systems designed for enterprise-wide deployment and use are comprised of a number of systems, sub-systems, and components. Such enterprise-wide computer systems include both hardware devices and software packages comprising an infrastructure for: wide and local area networks; file, database, application, terminal, storage, content, and mail servers; report generation, license management, backup, and communication services; client computers; fixed and portable terminal devices; devices to produce printed output; image display and projection devices; wired and wireless data collection devices; means for transferring data from data collection devices to enterprise data storage systems; means for computer, terminal, peripheral and network device connectivity; personnel management and tracking systems; project management and tracking systems; event scheduling, management, and tracking systems; and local and system-wide data and physical security.

Enterprise systems may require set-up of components or services including:
a) network infrastructure;
b) database servers;
c) list servers;
d) email and messaging servers;
e) report generation, license management, notification, scheduling, and communication services;
f) client computers or other terminals including portable, hand-held, and wearable devices;
g) telephony devices and services;
h) display and projection devices;
i) wired and wireless data-collection devices;
j) wired or wireless connectivity means between devices and services;
k) security tour- or patrol-specific parameters;
l) project management and tracking systems;
m) personnel and event scheduling, management or tracking systems and services; and
n) system security
   In this instance, “set-up” is defined as selecting or creating the object or system to be configured, setting some or all configuration parameters, defining connections between objects, systems, and services, and applying these parameters to the objects or systems.

In present systems such set-up tasks are typically performed with personal computers or other terminals, including hand-held and other portable devices. The resulting parameters are communicated in real-time or via batch processing to often disparate target systems. Each component is individually and independently configured which often requires highly specialized knowledge by persons experienced in computer systems.

### SUMMARY OF THE INVENTION

The present invention centralizes such set-up tasks and provides a user interface for a personal computer or other terminal. This approach simplifies the configuration of an enterprise system, decreases the number of errors, reduces the level of expertise required to configure the system and provides a visual representation of often complex systems, making such systems easier to comprehend.

In one embodiment of the present invention, the system operator interacts with the system through a graphical interface to generate a graphical representation of the network utilized by the computer system. This approach permits the system operator to “drag” graphic icons from a repository by using a mouse or other pointing device and to place the icons in a workspace area. The icons represent network components, software components and interconnections of the system to be configured. The properties of the components are then defined and links representing connections or the flow of data are created by drawing lines between components or by “dragging” icons representing such connections. The links and their properties are configured in the same manner. When the graphical representation of the network utilized by the computer system has been completed, a program is initiated using the graphical representation to properly configure and “set-up” the software required for the system. The resulting configuration diagrams and element properties can be saved to a storage means for later application, and can be printed for reference purposes. The repository of graphic icons is extendable so system operators can acquire and install additional enterprise elements as needed. Other embodiments can support other user interfaces as they are developed, allowing the invention to adapt to new technologies and platforms.

In another embodiment of the present invention, an enterprise-wide installation requires shared storage on a server. The personal computer or terminal-based application provides an “icon well” or repository from which the server icon can be shared or the shared storage resource can be “dragged” to the workspace. In the workspace area the properties for this shared server can be set, including server name, share name and path, security/permissions, and size and schedule-based limitations. A database must be created on this share. From the “icon well” a database icon is “dragged” to the workspace area. Properties such as database name are then set. A connector icon can then be “dragged” from the “icon well” to the workspace area and placed between the server and the database icons. This establishes the connection between the two resources indicating that the database resides on the specified server.

Using this same methodology, reports and notification services can be added and their properties set. The process can be continued until the graphical representation of the network utilized by the computer system has been completed. The system includes validation of all required parameters and provides messages to the operator when there are errors or incomplete parameter data. When the graphical representation of the network has been completed, it can be saved to the system, causing all new objects to be created and their properties to be set as previously defined. Appropriate error reporting is included in the output.

### BRIEF DESCRIPTION OF THE DRAWINGS

FIG. 1 is a diagram of objects representing an enterprise-wide deployment of a guard tour data collection and reporting system including local and wide area networks, wired and wireless devices, local and network printers, a server and data shares, Web services, and guard tour hardware and software components.

FIG. 2 is a representation of a small portion of the present invention utilizing a drag-and-drop graphical interface on a computer terminal.

### DESCRIPTION OF THE PREFERRED EMBODIMENT

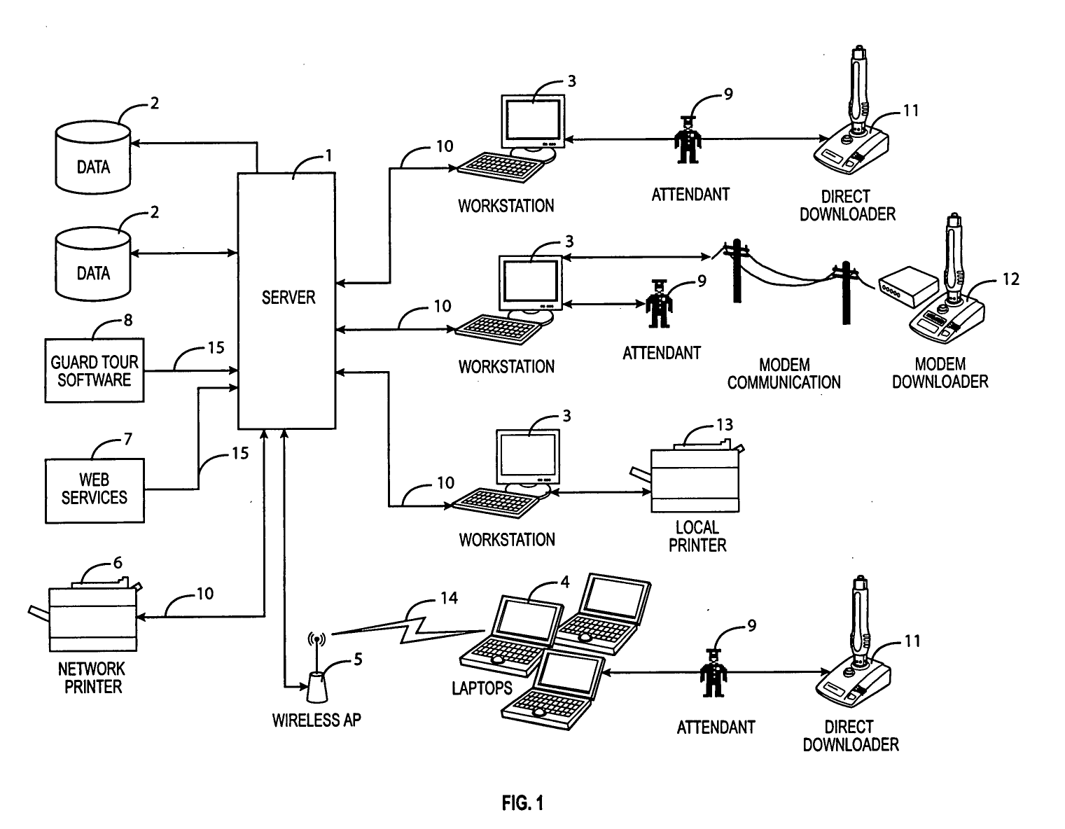

Referring now to the drawings where the illustrations are for the purpose of describing the preferred embodiment of the present invention and are not intended to limit the invention described herein, FIG. 1 illustrates hardware components, software, services, and other elements typical of an enterprise-wide deployment of a guard tour data collection and reporting system. In such-a data collection and reporting system, a central server 1 is connected to shared data storage devices 2, desktop work stations 3 (via wired connections 10), wireless access points 5, and a shared printer 6 (via wired connections 10). Web services 7, guard tour software 8 and other services required for the proper operation of the server 1 and connected systems are installed and operating on the server 1. Portable computer devices 4 may be provided and utilize wireless access points 5 for connection to the server 1 or may utilize connections similar to the wired connections 10 used to connect the workstations 3 and/or printers 6 to the server 1. Local printers 13 may be installed at the workstations 3 and at the portable computer devices 4. Wired connections 10 and wireless connections 14 are utilized between the various hardware devices, software, and services in the system to facilitate communication and the flow of information therebetween. In addition, “Virtual” connections 15 can be utilized, such as the connection 15 between the Web services 7, guard tour software 8, and the server 1.

Local data collection devices 11, such as a data downloader, are connected directly to the workstations 3 and/or to portable computer devices 4. Transfer of information between local data collection devices 11 and workstations 3 and/or portable computer devices 4 is controlled by software components 9. Remote data collection devices 12 may be connected to the workstations 3 and/or portable computer devices 4 by the use of telephone, wireless, or Internet connections. As with local data collection devices 11, communication with remote data collection devices 12 is controlled by software components 9.

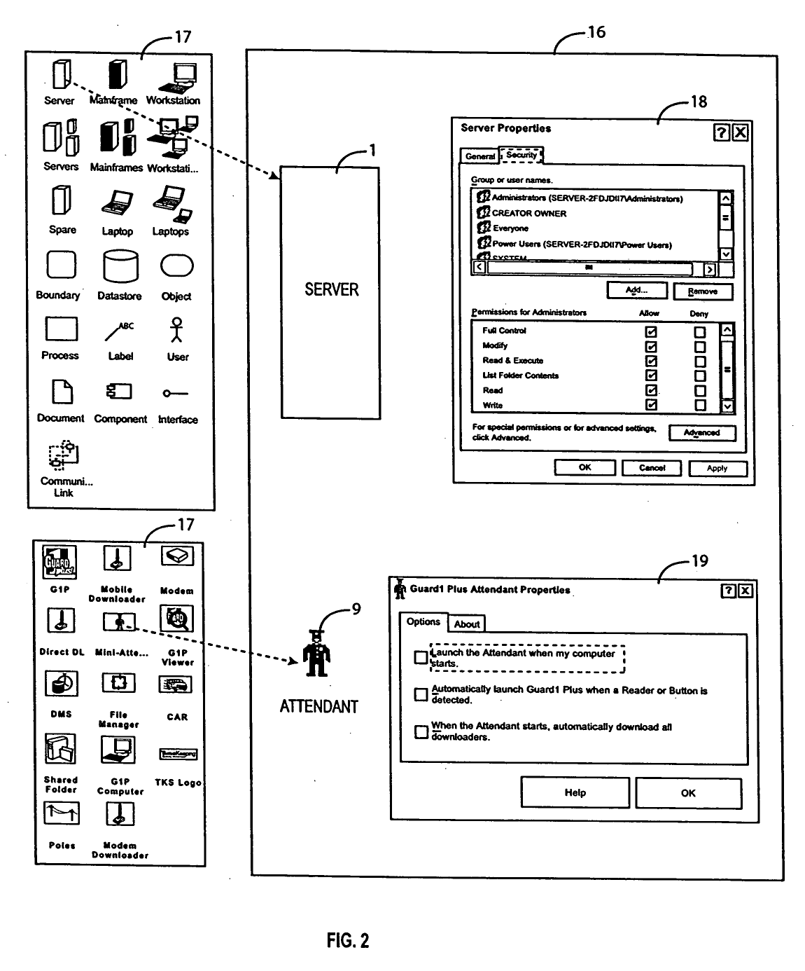

FIG. 2 illustrates the method by which an operator of the present invention graphically assembles the enterprise infrastructure on a computer or terminal. Icons representing hardware components, services, software, and interconnections are displayed in repositories 17. Repositories of standardized components, software, services and interconnections are contained within the present invention, and additional repositories and individual icons may be created or acquired and added to the present invention, as required, for further customization.

In FIG. 2, a server 1 is added to the enterprise by selecting an icon representing a server from the repository 17 by using a mouse or other pointing device. The icon is “dragged” by the mouse or other pointing device and “dropped” into the workspace 16. A representation of the server 1 then appears in the workspace 16. The operator may then invoke a properties form 18 for the server 1 into which configuration information is entered. Validation of operator entries and selections is performed by program logic to insure that the entries and selections are correct and appropriate for the type of device being configured.

A software component 9 for controlling communication between data collection devices 11, 12 and workstations 3 and/or portable computer devices 4 is added to the graphical representation of the network utilized by the computer system in the manner described previously. The operator may then invoke a properties form 19 for the software component 9 into which configuration information is entered. Validation of operator entries and selections is performed to insure that the entries and selections are correct and appropriate for the type of device being configured. In this manner, additional components, software, and services may be added to the graphical representation of the network, and each may be configured, as required. Wired connections 10, wireless connections 14 and “virtual” connections 15 may be added to the representation and configured in a similar manner.

If the present invention is utilized on systems connected to the infrastructure of the computer system, the operator may apply the configuration information directly to the graphical representation of the network. Program logic will confirm the presence and status of the components (servers, workstations, other physical components, software, and services) and perform the necessary software installations and parameter settings causing the computer system to be configured as defined by the graphical representation of the network and by the properties settings. If the present invention is not utilized on systems connected to the infrastructure, the configuration and properties settings defined by the graphical representation of the network may be stored in one or more files for later application to the target systems. Program logic will maintain audit trails of all access to the system and all installations and other configuration changes made to the target systems. Operator access and administration privileges will also be validated before any changes are allowed.

Certain modifications and improvements will occur to those skilled in the art upon reading the foregoing. It is understood that all such modifications and improvements have been deleted herein for the sake of conciseness and readability, but are properly within the scope of the following claims.

We claim:

1) A system for configuring an enterprise-wide computer system comprising a graphical interface, means for representing the infrastructure of said computer system on said graphical interface, said infrastructure comprising components and interconnections between said components of said computer system, means for defining the properties of said components and interconnections of said computer system, and means for utilizing said representation of said infrastructure of said computer system to configure the software required by said computer system.

2) The system as defined in claim 1 wherein said representation of said infrastructure of said computer system comprises an iconographic display on a computer terminal.

3) The system as defined in claim 1 further including means for storing said representation of said infrastructure of said computer system.

4) The system as defined in claim 1 further including means for printing said representation of said infrastructure of said computer system.
